(19) United States
(12) Patent Application Publication
(10) Pub. No.: US 2019/0266617 A1
(43) Pub. Date: Aug. 29, 2019

(54) READER REACTION LEARNING-BASED ARTICLE CATALOGING MANAGEMENT

(71) Applicant: INTERNATIONAL BUSINESS MACHINES CORPORATION, ARMONK, NY (US)

(72) Inventors: Inseok Hwang, Austin, TX (US); Su Liu, Austin, TX (US); Eric J. Rozner, Austin, TX (US); Chin Ngai Sze, Austin, TX (US)

(21) Appl. No.: 15/907,669

(22) Filed: Feb. 28, 2018

(51) Int. Cl. G06Q 30/02; G06Q 50/00

(52) U.S. Cl. CPC G06Q 30/0201; G06Q 50/01

(57) ABSTRACT

A method, computer system, and a computer program product for managing article cataloging based on predicting, verifying and updating an individual reader reaction is provided. The present invention may include identifying a reader. The present invention may then include retrieving personal characteristics associated with the reader. The present invention may also include categorizing the reader into user groups. The present invention may further include selecting and retrieving an article. The present invention may also include predicting a predicted reaction of the reader to the article. The present invention may also include monitoring the real-time reader reaction. The present invention may then include comparing the real-time reaction to the predicted reaction. The present invention may also include updating the real-time reaction of the reader to the article.

### BACKGROUND

The present invention relates generally to the field of computing, and more particularly to affective computing.

Social media analytics is one of the important features within affective computing. Since mobile devices are a major form of communication with billions of users, a large amount of unstructured information is generated. Browsing, sorting and managing articles are essential features in a social media analytics process, and the evaluation, cataloging and management of the articles are major tasks for social media, advertisement and information management vendors.

### SUMMARY

Embodiments of the present invention disclose a method, computer system, and a computer program product for managing article cataloging based on predicting, verifying and updating an individual reader reaction. The present invention may include identifying a reader. The present invention may then include retrieving a plurality of personal characteristics associated with the identified reader in a user profile associated with the identified reader. The present invention may also include categorizing the identified reader into a plurality of user groups based on the retrieved plurality of personal characteristics associated with the identified reader in the user profile associated with the identified reader. The present invention may then include selecting an article by the identified reader. The present invention may further include retrieving the selected article. The present invention may also include predicting a predicted reaction of the identified reader to the retrieved article. The present invention may then include monitoring a real-time reaction of the identified reader to the retrieved article. The present invention may also include comparing the monitored real-time reaction of the identified reader to the predicted reaction of the identified reader to the retrieved article. The present invention may further include updating the monitored real-time reaction of the identified reader into a piece of metadata associated with the retrieved article.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates a networked computer environment according to at least one embodiment;

FIG. 2 is an operational flowchart illustrating a process for managing the article cataloging based on predicting, verifying and updating an individual reader reaction on both server and client sides according to at least one embodiment;

FIG. 3 is an operational flowchart illustrating a process for server-side reader reaction prediction according to at least one embodiment;

FIG. 4 is an operational flowchart illustrating a process for client-side reader reaction verification according to at least one embodiment;

FIG. 5 is an operational flowchart illustrating a process for server-side reader reaction updating according to at least one embodiment;

FIG. 6 is an operational flowchart illustrating a process for managing article cataloging in server-side according to at least one embodiment;

FIG. 7 is a block diagram of internal and external components of computers and servers depicted in FIG. 1 according to at least one embodiment;

FIG. 8 is a block diagram of an illustrative cloud computing environment including the computer system depicted in FIG. 1, in accordance with an embodiment of the present disclosure; and

FIG. 9 is a block diagram of functional layers of the illustrative cloud computing environment of FIG. 8, in accordance with an embodiment of the present disclosure.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. Rather, these exemplary embodiments are provided so that this disclosure will be thorough and complete and will fully convey the scope of this invention to those skilled in the art. In the description, details of well-known features and techniques may be omitted to avoid unnecessarily obscuring the presented embodiments.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language, Python programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The following described exemplary embodiments provide a system, method and program product for cataloging an article based on individual reader reaction. As such, the present embodiment has the capacity to improve the technical field of affective computing by defining a method for utilizing individual reader reaction based on article cataloging management for intelligently collecting user emotion reaction to each article, improving unstructured information cataloging, and enhancing social media analytics. More specifically, the article cataloging management program may predict the reader reaction to an article before the reader reads the article. Then, the article cataloging management program may monitor the real-time reaction of the reader by utilizing biometric devices. The article cataloging management program may then compare the predicted reader reaction with the monitored real-time reader reaction, and update an emotional index associated with the article to reflect the reader reaction to the article. The updated emotional index to the article may be stored in a database with the article for easy retrieval, thereby improving unstructured information cataloging and enhancing social media analytics.

As described previously, social media analytics is one of the important features within affective computing. Since mobile devices are a major form of communication with billions of users, a large amount of unstructured information is generated. Browsing, sorting and managing articles are essential features in a social media analytics process, and the evaluation, cataloging and management of the articles are major tasks for social media, advertisement and information management vendors.

There are numerous existing methods for evaluating articles and their respective bloggers, websites or hosts from different aspects for different purposes. However, these article popularity index methods may not accurately reflect readers, or opinions from different user groups, and may be static and lack customization for different readers from different user groups. In fact, readers with different backgrounds (e.g., education, socioeconomic status, political affiliation, culture, race, nationality, job, gender and age) may exhibit vastly different reactions to the same article. For example, a person may provide positive comments after reading an article, while a different reader from a different gender may provide negative feedback on the same article. Such personal characteristic-based reactions are more valuable for affective computing analysis and related services (e.g., personalized push, advertisement or survey). As such, collecting, cataloging and tagging those personal characteristic-based reactions may be helpful to enhance affective computing analysis on social media analytics.

Therefore, it may be advantageous to, among other things, define a method of article cataloging management based on individual reader reaction for improving unstructured information cataloging and enhancing social media analytics.

According to at least one embodiment, the article cataloging management program may intelligently collect user emotional reaction (i.e., reader reaction) on each read article, improve unstructured information cataloging, and enhance social media analytics. The present embodiment may include three main processes: reaction prediction, reaction verification and reaction updating. In the reaction prediction process, the article cataloging management program predicts the reader's reaction to a new article based on the user groups associated with the reader (i.e., reader groups) and the existing data on the reader. The reaction verification process may verify the accuracy of the article cataloging management program's reaction prediction by monitoring the reader's reaction while the reader reads the article, thereby generating a real-time reaction. If the reaction prediction of the article cataloging management program fails to match the real-time reaction, then the article cataloging management program may initiate the reaction updating process. The emotional index for the particular article may be updated, as well as the emotional index associated with the reader's user groups for the particular article. The article cataloging management program may utilize the data collected from the three processes to perfect two known algorithms (i.e., emotion-related algorithm and cognitive learning algorithm) utilized to determine reader reaction to arbitrary or new articles.

According to at least one embodiment, the article cataloging management program may perform on a server-side. In server-side, the article cataloging management program may define the criteria of article user groups, article reading reaction dimensions and patterns, and reader reaction index. The article cataloging management program may then retrieve the personal characteristics of the reader from the user profile and reading history of the reader. Then, the article cataloging management program may categorize the reader into a user group based on the personal characteristics of the reader, and receive the real-time reaction by the reader's device. The article cataloging management program may then collect reader's other activities, such as sharing, comments, and other reactions. Then, the article cataloging management program may update and merge the reader reaction tags (i.e., emotional index) into the article metadata according to the categorized user group, and sort the articles based on the tagged reader reaction index for the different user groups. The article cataloging management program may then categorize each reader reaction on each read article, and classify an arbitrary article based on the categorized user groups and article types. The article cataloging management program may then search and filter articles based on the tagged reader reaction index from the different user groups. In the present embodiment, the server-side may also predict the reader reaction to an article while the reader is selecting the article from a database based on the existing data associated with the reader.

According to at least one embodiment, the article cataloging management program may classify an arbitrary article into a specific class of articles based on the user groups associated with that arbitrary article and the article type (e.g., specific topic, article form). The article cataloging management program may generate a predicted reaction for the arbitrary article based on the real-time reaction to another article, previously read by the user group, that is in the same class as the arbitrary article.

The present embodiment may perform on another phase, client-side. In client-side, the article cataloging management program may identify the reader and monitor the real-time reaction of the reader to each article by utilizing sensors and devices connected to the reader. The article cataloging management program may then digitize the reader reaction of the current reader associated with the article. The real-time and predicted reaction may be compared and the reaction tag from the article may be updated. Then, the article cataloging management program may tag the article with the digitized emotional index (i.e., reaction tag), and save and upload the reaction tags into the metadata corresponding with the read article.

According to at least one embodiment, the article cataloging management program may include a real-time reaction based on article emotional tag customization and management method or service for tagging and cataloging read articles (e.g., blogs, posts, news). The present embodiment may include a method to manage “Likes” or “Dislikes” tags based on personal characteristics.

According to at least one embodiment, the article cataloging management program may include a cognitive emotional tag learning-based customizer. There may be two possible inputs from user reactions in the article cataloging management program. First, if the predicted emotion tags (i.e., reader reaction) associated with the reader are the same as the real-time reader reaction (i.e., derived from biometric and sentiment input), then the article cataloging management program may increase emotion reaction confidence or the weight of the used input for emotion-related and cognitive learning algorithms. If, however, the predicted emotion tag for the reader is different from the real-time reader reactions or the associated reader group, then the article cataloging management program may adjust the used input for the algorithms for the reader and the associated reader group. Additionally, the article cataloging management program may either create a new group (i.e., if the reaction is a new emotion for the article) or move the reader to a different group which matches the reader's real-time reaction.

According to at least one embodiment, the article cataloging management program may include an emotional reaction tagging daemon (i.e., associated program or application). The emotional reaction tagging daemon may monitor human-Article affective changes, then create, modify, or update an Article-emotional index for certain user groups. The emotional reaction tagging daemon may predict a reader reaction for a new article which has yet to be read by the reader (i.e., user), search for new article's class information, and search for the overall reader reaction to various articles in the same class. The present embodiment may include an emotional filter (i.e., module), which filters articles based on reader emotional preference.

According to at least one embodiment, the article cataloging management program may include an article reader categorizer and article user groups. The article reader categorizer may be a module for categorizing different article readers into different user groups based on the collected and saved personal characteristic information associated with each reader. The article user groups may include a set of groups that are clustered based on personal characteristic information associated with each reader. For example, Portuguese male and female users may be grouped into a Portuguese group, and then categorized into subgroups due to their differences in emotion reaction presented while the users read an article.

According to at least one embodiment, the article cataloging management program may include user profiles and a user personal characteristic parser. The user profiles may be a file or database for saving personal characteristic information for customizing article emotional tag management. The profile may be created, modified, and updated by either users (i.e., readers) or service providers. The user personal characteristic parser may include a program or module to parse personal characteristics associated with readers.

According to at least one embodiment, the article cataloging management program may include an article browser and article loader. The article cataloging management program may utilize the article browser (e.g., web browser) or application (e.g., blog reader, library article manager) for reading articles. The article loader may be utilized as an enhanced article loading program or application program interface (API) for loading an article with metadata data from an article server or article file storage management system on local. The present embodiment may include an article request receiver. The article cataloging management program may utilize an article request receiver as an API for receiving user article reviewing requests.

According to at least one embodiment, the article cataloging management program may utilize an emotional tag configuration graphical user interface (GUI). The emotional tag configuration GUI may serve as a user interface for configuring emotional tag settings and managing personal characteristic information. A set of personal emotion tagging criteria may be configured through the GUI and saved onto user profiles.

According to at least one embodiment, the article cataloging management program may include emotional detection modules. The emotion detection modules may be external or internal devices for collecting emotional input (e.g., a set of emotion detection sensors, modules on article reading device, wearable device). For example, a semantic content analysis module with biometric input via biometric sensors (i.e., facial recognition, heartbeat monitor, pace of breathing monitor, behavioral pattern recognition) and signals through wearable health or fitness devices, or mobile application. The present embodiment may include an emotional reaction monitor, a program to monitor changes of user emotion, as well as related and communicated contexts during a communication.

According to at least one embodiment, the article cataloging management program may utilize an emotional dimensions and index. The emotional dimensions and index may include an emotion list of different types of emotions and feelings (e.g., love, joy, surprise, anger, sadness, fear). The reader may select a default emotional dimensions and index standard from a variety of different international or regional sources. In the present embodiment, the article cataloging management program may include an emotional digitizer. The emotional digitizer may be a module for normalizing and digitizing emotional index into a comparable numeric value with grouping tags. For example,

Article-i (emotional index)=PT-Female−Valence 80%

The above tags may indicate that the emotional index is 80% for a Portuguese female, in average.

According to at least one embodiment, the article cataloging management program 110a, 110b may be utilized as a standalone application. The present embodiment may include the integration of the article cataloging management program 110a, 110b into a server-client framework, or cloud Software as a service (SaaS) API service.

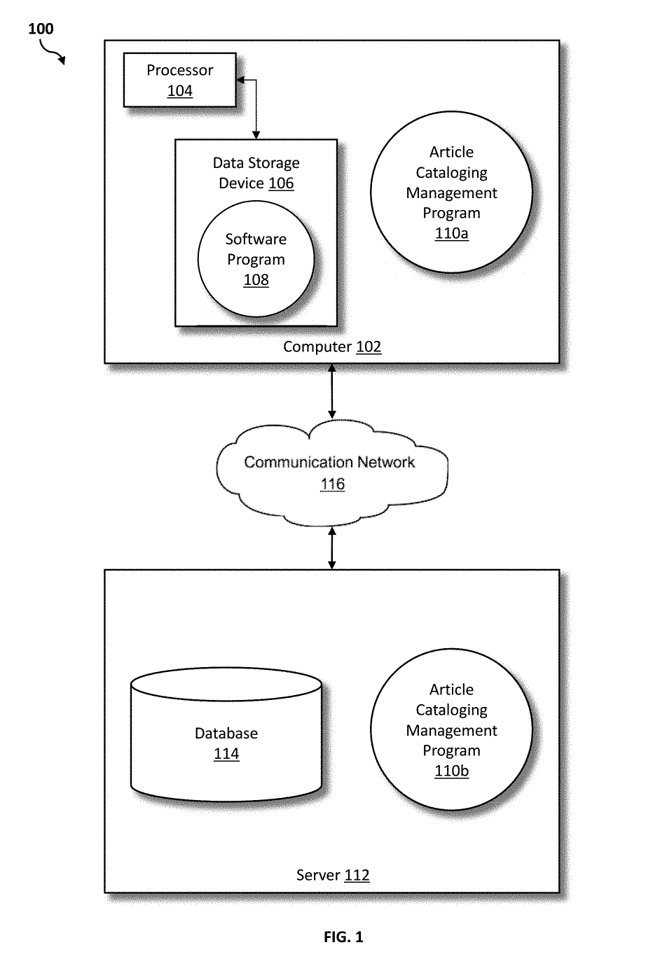

Referring to FIG. 1, an exemplary networked computer environment 100 in accordance with one embodiment is depicted. The networked computer environment 100 may include a computer 102 with a processor 104 and a data storage device 106 that is enabled to run a software program 108 and an article cataloging management program 110a. The networked computer environment 100 may also include a server 112 that is enabled to run an article cataloging management program 110b that may interact with a database 114 and a communication network 116. The networked computer environment 100 may include a plurality of computers 102 and servers 112, only one of which is shown. The communication network 116 may include various types of communication networks, such as a wide area network (WAN), local area network (LAN), a telecommunication network, a wireless network, a public switched network and/or a satellite network. It should be appreciated that FIG. 1 provides only an illustration of one implementation and does not imply any limitations with regard to the environments in which different embodiments may be implemented. Many modifications to the depicted environments may be made based on design and implementation requirements.

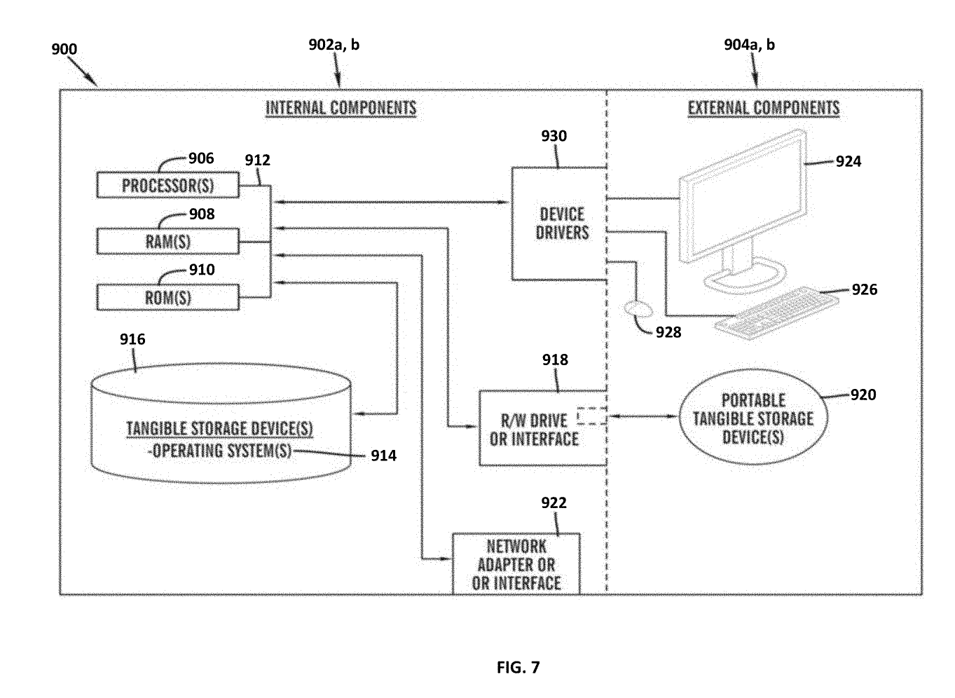

The client computer 102 may communicate with the server computer 112 via the communications network 116. The communications network 116 may include connections, such as wire, wireless communication links, or fiber optic cables. As will be discussed with reference to FIG. 7, server computer 112 may include internal components 902a and external components 904a, respectively, and client computer 102 may include internal components 902b and external components 904b, respectively. Server computer 112 may also operate in a cloud computing service model, such as Software as a Service (SaaS), Analytics as a Service (AaaS), Platform as a Service (PaaS), or Infrastructure as a Service (IaaS). Server 112 may also be located in a cloud computing deployment model, such as a private cloud, community cloud, public cloud, or hybrid cloud. Client computer 102 may be, for example, a mobile device, a telephone, a personal digital assistant, a netbook, a laptop computer, a tablet computer, a desktop computer, or any type of computing devices capable of running a program, accessing a network, and accessing a database 114. According to various implementations of the present embodiment, the article cataloging management program 110a, 110b may interact with a database 114 that may be embedded in various storage devices, such as, but not limited to a computer/mobile device 102, a networked server 112, or a cloud storage service.

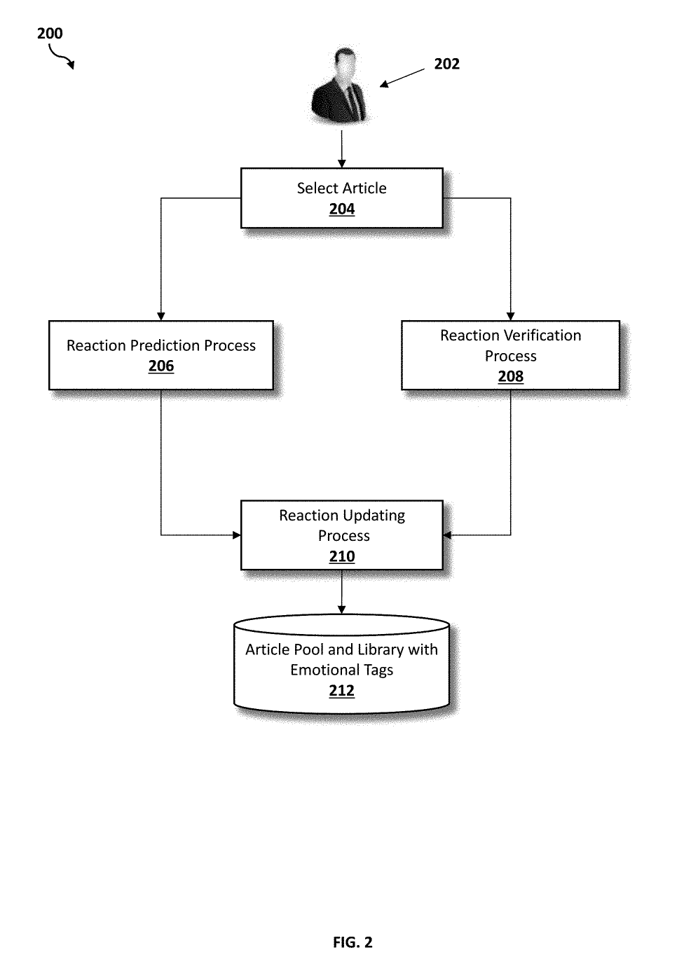

According to the present embodiment, a user using a client computer 102 or a server computer 112 may use the article cataloging management program 110a, 110b (respectively) to manage individual reaction learning based article cataloging to enhance social media analytics. The article cataloging management method is explained in more detail below with respect to FIGS. 2-6.

Referring now to FIG. 2, an operational flowchart illustrating the exemplary process for managing an article cataloging based on reader reaction for both server and client sides 200 used by the article cataloging management program 110a and 110b according to at least one embodiment is depicted.

As shown, a reader 202 selects an article at 204. Using a software program 108 on the reader's device, the reader (i.e., user) 202 may access a known article browser (e.g., web browser) or application (e.g., blog reader, library article manager) for reading articles associated with the article cataloging management program 110a, 110b via a communication network 116. Alternatively, the reader 202 may access a known article request reviewer (i.e., an API for receiving user article reviewing request) on the server-side of the article cataloging management program 110a, 110b via a communication network 116. By utilizing the article request reviewer, the reader 202 may request the specific article, so long as the requested article is stored in the article pool and library with emotional tags (e.g., database 114) associated with the article cataloging management program 110a, 110b.

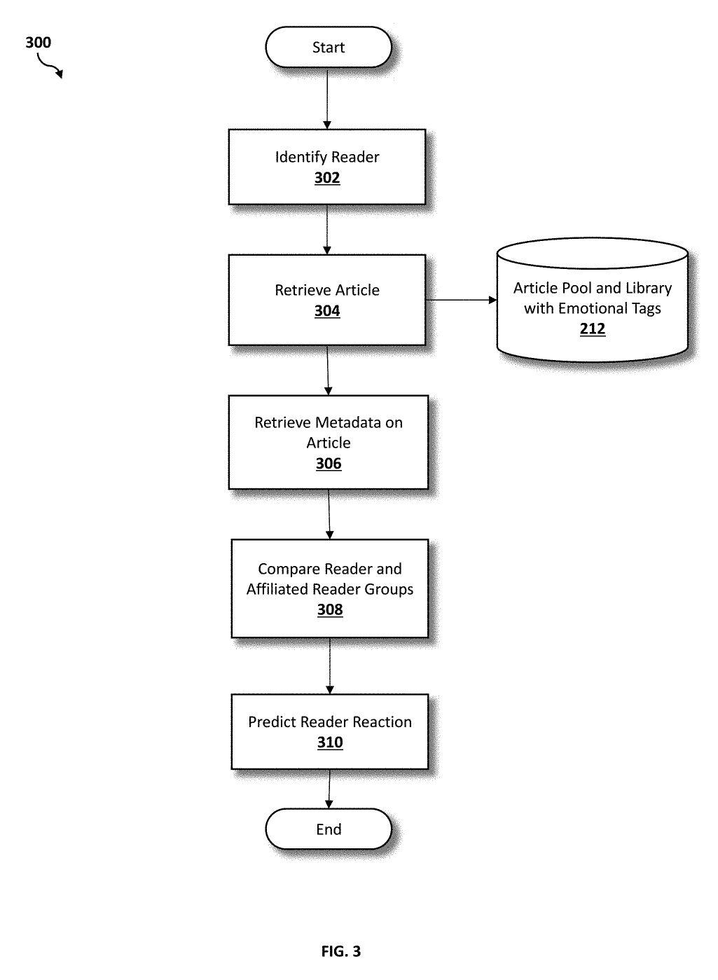

Then at 206, the article cataloging management program 110a, 110b performs the reaction prediction process. As the reader 202 selects the article at 204, the article cataloging management program 110a, 110b may perform the reaction prediction process 206 in which the article cataloging management program 110a, 110b may predict the reader reaction based on existing data on the reader 202. A detailed operational flowchart of the reaction prediction process in the article cataloging management program 110a, 110b will be described in greater detail below with respect to FIG. 3.

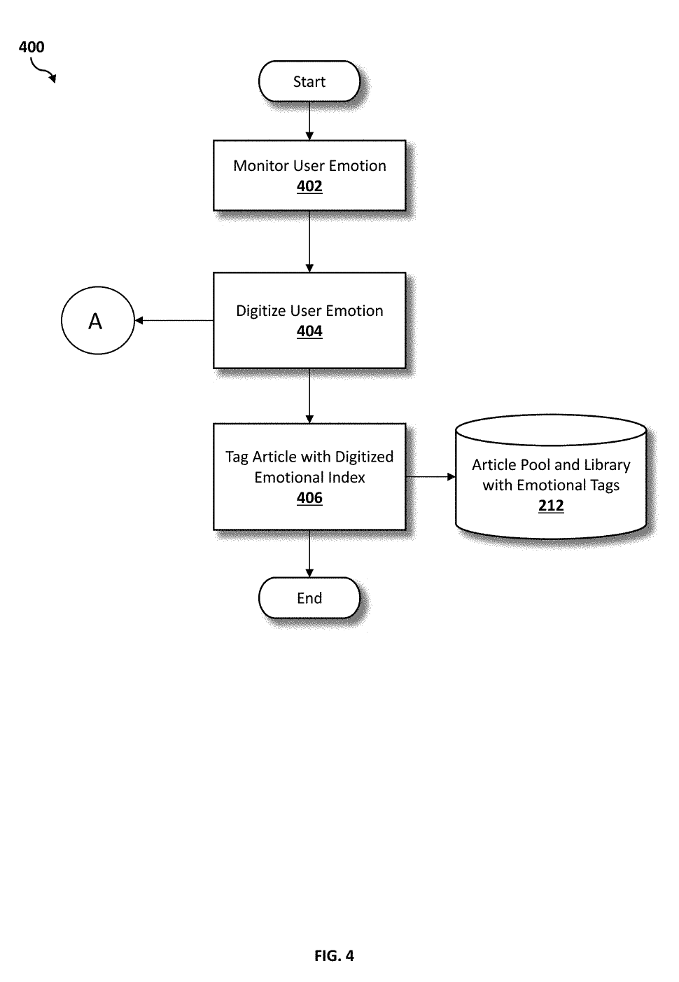

Then, at 208, the article cataloging management program 110a, 110b simultaneously performs the reaction verification process in which the article cataloging management program 110a, 110b monitors the reader reaction to the article by utilizing biometric detection (i.e., network of physical devices, vehicles, home appliances and other items embedded with electronics, software, sensors, actuators and network connectivity which enables these objects to connect and exchange data) to determine the real-time reader reaction to the selected article. A detailed operational flowchart of the reaction verification process in the article cataloging management program 110a, 110b will be described in greater detail below with respect to FIG. 4.

In another embodiment, the article cataloging management program 110a, 110b may perform the reaction prediction process at 206 and the reaction verification process at 208 consecutively. For example, the article cataloging management program 110a, 110b may perform the reaction prediction process at 206 before the reaction verification process at 208, or the article cataloging management program 110a, 110b may perform the reaction verification process at 208 before the reaction prediction process at 206.

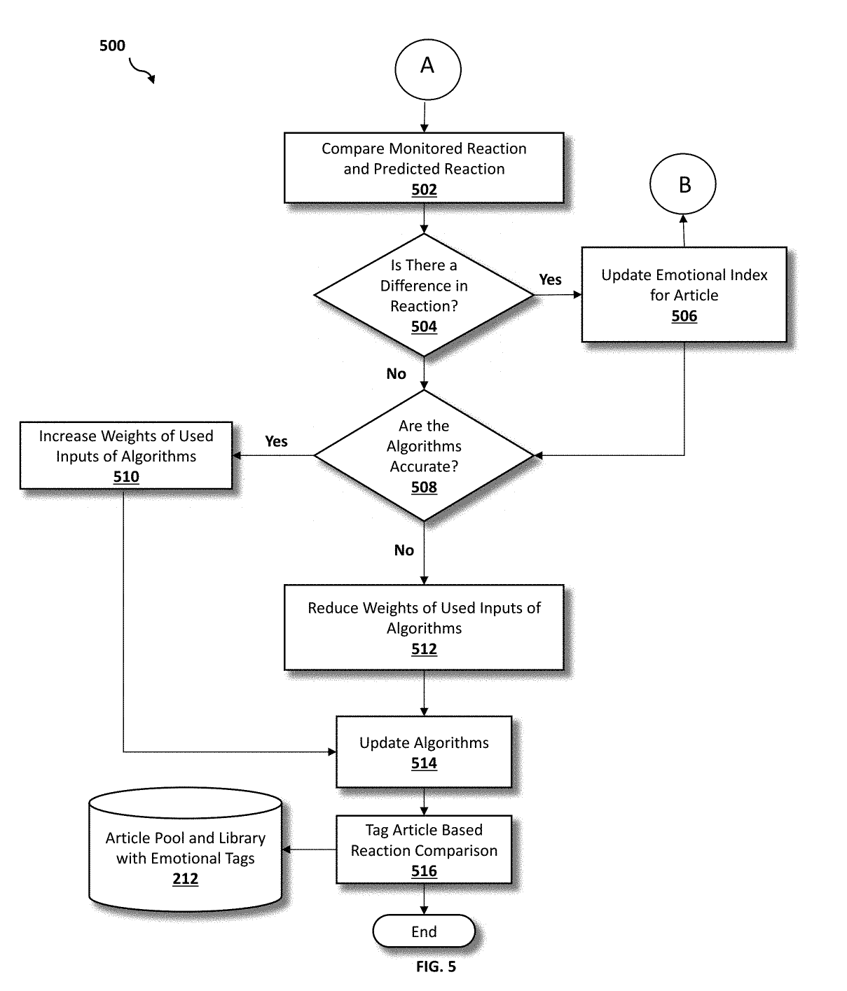

Then, at 210, the article cataloging management program 110a, 110b commences the reaction updating process. In the reaction updating process 210, the article cataloging management program 110a, 110b may analyze the predicted reaction generated by the reaction prediction process 206 and the real-time reader reaction generated by the reaction verification process 208. During the reaction updating process 210, the metadata associated with the read article may be updated based on whether the real-time reaction matches the predicted reader reaction. The reader 202's emotional index (i.e., reader reaction tag) to the read article may be stored in the article metadata in the article pool and library with emotional tags 212. A detailed operational flowchart of the reaction updating process in the article cataloging management program 110a, 110b will be described in greater detail below with respect to FIG. 5.

In the present embodiment, the article cataloging management program 110a, 110b may loop to reader 202 when the same reader 202 or different reader 202 selects the previously selected article. If the reader 202 selects the previously selected article with an emotional tag, then the article with the corresponding emotional tag may loop to 202, where a different reader 202 or the same reader 202 may review the previously selected article.

Referring now to FIG. 3, an operational flowchart illustrating the exemplary process for server-side reader reaction prediction 300 used by the article cataloging management program 110a and 110b according to at least one embodiment is depicted.

At 302, a reader 202 is identified. The article cataloging management program 110a, 110b may identify the reader 202 by prompting the reader 202 (e.g., via dialog box) to provide the user name associated with the reader 202. The dialog box, for example, may include a comment “Username” with a blank comment box to the right. Once the reader 202 enters the username associated with the reader 202, the reader 202 may select the “Submit” button located below. For example, the reader 202 is a return user. Therefore, the user enters the reader 202's name “FUNNYSPORT47” and clicks the “Submit” button.

If, however, the reader 202 is first-time user, then, according to at least one implementation, the reader 202, for example, may click the “First-Time User” button located to the left of the “Submit” button in the dialog box. The reader 202 may then be prompted (e.g., via dialog box) to create a user profile with personal characteristics of the reader 202. Once the reader 202 finished setting up the user profile, then the reader 202 may click the “Finish” button located on the bottom of the dialog box. The created user profile may then be stored on a separate database 114 associated with the article cataloging management program 110a, 110b. Each time that the reader 202 logs into the article cataloging management program 110a, 110b with the reader 202's username, the generated information (e.g., books read, user emotion) may be saved on that separate database 114 of the article cataloging management program 110a, 110b. Additionally, the user profile may be created, modified or updated by the user or service providers.

In another embodiment, the reader 202 may be identified prior to changing any of the criteria or settings in the article cataloging management program 110a, 110b. On the main screen for the article cataloging management program 110a, 110b, there may be a “Criteria” button located at the bottom right side of the screen. Once the reader 202 clicks on the “Criteria” button, the reader 202 may be prompted (e.g., via dialog box) to confirm the identification of the reader 202. The reader 202's name is presented at the top of the dialog box, with “Yes” or “No” buttons underneath. If the reader 202's name matches the name presented in the dialog box, the reader 202 selects the “Yes” button and the article cataloging management program 110a, 110b retrieves the reader 202's user profile. If, however, the name did not match the reader 202's name, then the reader 202 may click the “No” button in which another dialog box may appear for the reader 202 to include the reader 202's name for the article cataloging management program 110a, 110b to retrieve the reader 202's user profile.

Then, at 304, an article is retrieved. Regardless of whether the reader 202 utilized the article browser or the article request reviewer, the reader 202 may utilize a known article loader (e.g., an enhanced article loading program or API) for loading the article from the article pool and library with emotional tags 212, or an article file storage management system on various storage devices, such as, a computer/mobile device 102, a networked server 112, or a cloud storage service associated with the article cataloging management program 110a, 110b.

Additionally, the article cataloging management program 110a, 110b may start to view Article-i (i.e., emotional index) associated with the reader 202 after the reader 202 starts to browse or request an article. The article cataloging management program 110a, 110b may review the Article-i after an article has been selected and loaded by the article loader. The article cataloging management program 110a, 110b may utilize the emotional index to provide more dimensions to an article popularity analysis within a certain reader group. By utilizing the emotional index, the article cataloging management program 110a, 110b may determine the different reactions of different readers 202 on each read article, classify an arbitrary article based on the categorized reader group and types of articles, predict the reader reactions to a brand new article which has yet to be read, search for a new article's class information and the overall reader reaction to various articles in the same class, and search and filter articles based on the tagged reading reaction indexes from different user groups.

Continuing the previous example, the reader 202, “FUNNYSPORT47,” is traveling on a commuter train, when the reader 202 utilizes a smartphone to read an article. The reader 202 uses the article browser on the smartphone to browse recent articles on gene sequencing. After ten minutes of reviewing articles in the article browser, the reader 202 selects an article on the recent advancements in gene sequencing. The reader 202 then utilizes the article loader to upload the article from the article pool and library with emotional tags 212. While the reader 202 is browsing for the article, the article cataloging management program 110a, 110b starts to view the reader 202's Article-i. The reader 202's Article-i exhibits a high level of anticipation, while the reader 202 is browsing. The Article-i then changes to a high level of joy after the reader 202 selects the article.

In the present embodiment, the article cataloging management program 110a, 110b may utilize an emotional filter in which articles may be filtered based on the user emotion preferences stored in a user profile on the server-side of the article cataloging management program 110a, 110b.

At 306, metadata on the article is retrieved, while the article is loaded by the known article loader. Each loaded article may include metadata (i.e., previous reader reaction tags and emotional index of each reader 202 and the user groups that previously read the article on the article cataloging management program 110a, 110b). The metadata may be stored with the corresponding article in the in the article pool and library with emotional tags 212.

Continuing the previous example, the metadata corresponding with the article on recent advancements in gene sequencing includes the emotional index to the article for three user groups and readers 202 that read the article. The three user groups are the Baby Boomers group, the Molecular Biologists group and the Cancer Survivors and Supporters group. In the Molecular Biologists and the Cancer Survivors and Supporters groups, the Article-i for the article ranges from 45-60% with the reader reaction including anticipation, anger and confusion. In the Baby Boomers group, however, the Article-i for the article is 91% with the reader reaction including anticipation and excitement.

Then, at 308, the reader 202 and the affiliated user groups are compared. To predict the reader 202's emotional reaction, the article cataloging management program 110a, 110b may compare the existing data in the reader 202's profile with the user groups associated with the reader 202. The comparison may determine whether the reader 202 is more or less likely to have a favorable or unfavorable reader reaction to the article based on the reaction of the associated user groups and the reader 202's previous reactions to other articles. For example, if the reader 202's previous reaction matches the previous reactions of the reader group to the same articles, then the reader 202's reactions to the current article will most likely match that of the reader group.

Continuing the previous example, based on previous reactions of the reader 202 to other articles read by other readers 202 in the associated Baby Boomers group, FUNNYSPORT47 generally expresses less positive reader reactions to the articles than other readers 202 in the Baby Boomers group.

Then, at 310, the reader reaction is predicted. The article cataloging management program 110a, 110b may utilize the known emotional reaction tagging daemon to predict the reader reaction of the reader 202 to the new article. The emotional reaction tagging daemon may search for the class information of the retrieved article, and the overall reader reactions to articles within the same class. Based on the existing data on the reader 202 and associated user groups, the article cataloging management program 110a, 110b may predict the reader reaction to the retrieved article.

Continuing the previous example, the article cataloging management program 110a, 110b predicts that FUNNYSPORT47 would express excitement and anticipation to the article on the recent advancements in gene sequencing. However, the emotional index for FUNNYSPORT47 would be less than the overall reader reaction of the Baby Boomers group, and therefore, the article cataloging management program 110a, 110b predicts FUNNYSPORT47's emotional index to be 80% as opposed to 91% for the overall Baby Boomers group.

In the present embodiment, each newly collected arbitrary article may be assigned a default emotional index value either based on the similarity of collected articles, or sentiment analysis. For example, if the article cataloging management program 110a, 110b collects a new article written by a particular author, then the article cataloging management program 110a, 110b may assign the same emotional tag associated with the reader reaction to another article written by the same author.

Referring now to FIG. 4, an operational flowchart illustrating the exemplary process for client-side reader reaction verification 400 used by the article cataloging management program 110a and 110b according to at least one embodiment is depicted.

At 402, user emotion is monitored. At least one emotional detection module (e.g., semantic input, biometric input, facial recognition, iris recognition, retinal recognition, or other suitable technique) may be utilized by the reader 202 to collect the emotional input. The article cataloging management program 110a, 110b may utilize a known emotional reaction monitor (i.e., program) to monitor changes to the emotion of the reader 202 as indicated by the emotional detection module.

Additionally, after the user emotion is monitored, the article cataloging management program 110a, 110b may begin the reaction updating process 500. A detailed operational flowchart of the reaction updating process in the article cataloging management program 110a, 110b will be described in greater detail below with respect to FIG. 5.

Continuing the previous example, the reader 202 is wearing a fitness wristband that collects the reader 202's heart and pulse rates, and pace of breathing to calculate the Article-i. The fitness wristband is connected to the article cataloging management program 110a, 110b via an application on the reader 202's smartphone.

Then, at 404, user emotion associated with the article is digitized. Prior to the reader 202 browsing or requesting an article, the article cataloging management program 110a, 110b may utilize a known Emotional Dimensions and Index (i.e., emotional cataloging standards and rules). The Emotional Dimensions and Index may create a default list of emotions that may be collected by the emotional detection module and monitored by the emotional reaction monitor. The user emotion or emotional index to the retrieved article may be normalized and digitized by utilizing a known emotional digitizer (i.e., a module). A comparable numeric value with grouping tags may be generated from the digitized user reaction.

Continuing the previous example, the reader 202 previously selected an Emotional Dimensions and Index standard, and the Article-i is based on this previously determined standard. The reader 202's user emotion to the article on recent advancements in gene sequencing is then digitized by an emotional digitizer and the following comparable numeric value with grouping tags is generated:

Article-i=FUNNYSPORT47−Valence (70%)

### Therefore, the Article-i is 70% for FUNNYSPORT47.

Then, at 406, the article is tagged with the digitized emotional index. The article cataloging management program 110a, 110b may update the emotional index with the corresponding retrieved article. The article cataloging management program 110a, 110b may distinguish an original emotional index associated with the retrieved article from an updated emotional index associated with the retrieved article. By utilizing a known emotional reaction tagging daemon (i.e., a program or application for monitoring the emotional index changes in a particular reader 202), the emotional index may be updated thereby creating a tag with the retrieved article to include the digitized emotional index of the reader 202. As such, the retrieved article may be tagged with the updated emotional index. The article cataloging management program 110a, 110b may save and upload the created tag for the retrieved article which may be stored as a part of the metadata in the article pool and library with emotional tags 212.

Additionally, the emotional reaction tagging daemon may be utilized to create, modify or update the emotional index of the retrieved article for a certain user group associated with the reader 202. The generated emotional index for the retrieved article for the user group may also be saved and uploaded into the retrieved article metadata in the article pool and library with emotional tags 212. A detailed operational flowchart of the reaction updating process in the article cataloging management program 110a, 110b will be described in greater detail below with respect to FIG. 5.

Continuing the previous example, the article cataloging management program 110a, 110b includes an Article-i of 70% for FUNNYSPORT47 with this article on recent advancements on gene sequencing. The article with the generated emotional index is then stored in the article pool and library with emotional tags 212.

In another embodiment, the updated emotional index and a specified real-time reaction (i.e., digitized emotional index) may be the same value if the article cataloging management program 110a, 110b is focused on a personal level (e.g., for a specific person).

In another embodiment, the article cataloging management program 110a, 110b may rebuild the updated emotional index each time a new real-time reaction (i.e., digitized emotional data) is received to customize a user group (e.g., music fan, sports fan, IT experts).

Referring now to FIG. 5, an operational flowchart illustrating the exemplary process for server-side reader reaction updating 500 used by the article cataloging management program 110a and 110b according to at least one embodiment is depicted.

At 502, the monitored real-time reaction of the reader 202 and the predicted reaction of the reader 202 are compared. After the real-time reaction (i.e., user emotion) is monitored at 402 during the reaction verification process 400, the monitored real-time reaction generated at 402 may be further analyzed during the reaction updating process 500. The article cataloging management program 110a, 110b may compare the real-time reader reaction to the article at 402 and the predicted reader reaction to the article at 310 by utilizing the known emotional reaction tagging daemon.

Continuing the previous example, FUNNYSPORT47's real-time reaction is 70% to the article as compared to the predicted reaction of 80%.

Then, at 504, the article cataloging management program 110a, 110b determines whether the real-time reaction at 402 and the predicted reader reaction at 310 are different. Since the predicted reaction may be based on the previous emotional index associated with the retrieved article in the user group, the comparison of the real-time reaction at 402 and the predicted reader reaction at 310 may compare the old and new emotional index for the retrieved article in the user group. The comparison may cause the article cataloging management program 110a, 110b to update the emotional index associated with the retrieved article in the user groups associated with the reader 202. Additionally, the comparison may assist the article cataloging management program 110a, 110b with perfecting a known emotion-related algorithm and a known cognitive learning algorithm.

If the article cataloging management program 110a and 110b determines that the real-time reaction to the article is different from the predicted reader reaction at 504, then the article cataloging management program 110a and 110b may update the emotional index for the user group at 506. The article cataloging management program 110a, 110b may receive an unexpected reaction from the reader 202, when the real-time reaction was monitored. As such, the article cataloging management program 110a, 110b may update the emotional index attributed to the article in the user groups associated with the reader 202.

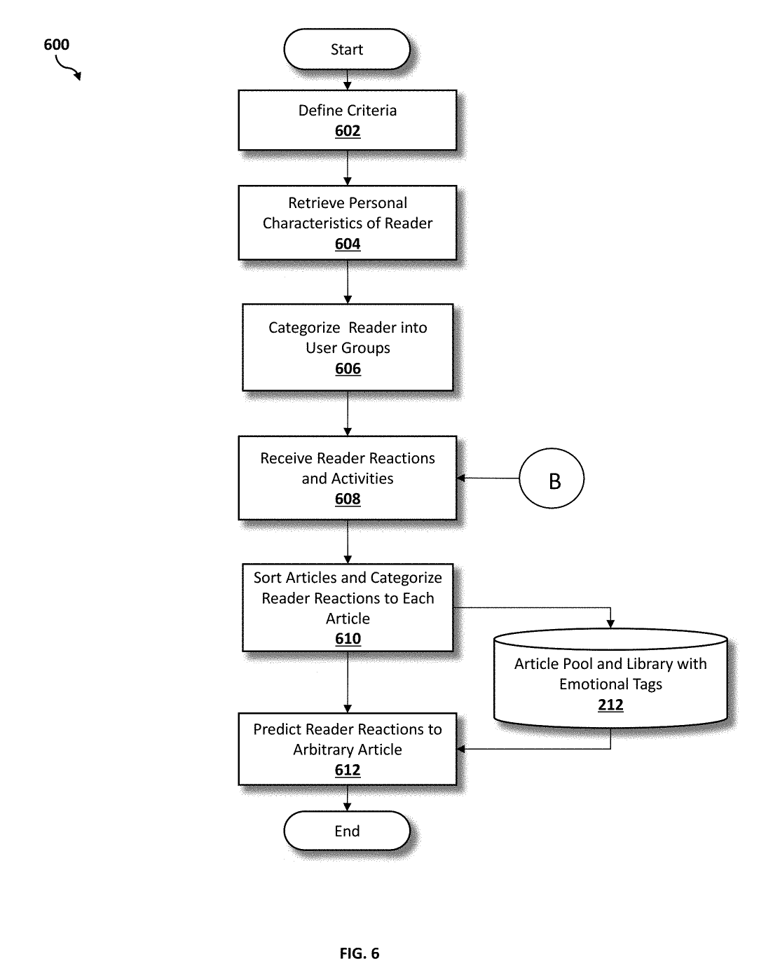

Additionally, the user profile associated with the reader 202 may also be updated to reflect the reader 202's reaction to the retrieved article. The article with the real-time reader reaction may be included in the reading history associated with the particular reader 202 in the user profile. As such, the server-side of the article cataloging management program 110a, 110b may utilize the updated emotional index. A detailed operational flowchart of the article cataloging management process on the server-side in the article cataloging management program 110a, 110b will be described in greater detail below with respect to FIG. 6.

Continuing the previous example, the article cataloging management program 110a, 110b receives an unexpected reaction in which the monitored reader reaction is 70% as opposed to the predicted reader reaction, which is 80%. As such, the article cataloging management program 110a, 110b updated the emotional index attributed to the article in the Baby Boomers group. Based on the reactions of other readers 202 associated with the Baby Boomers group, who read the article on the recent advancements in gene sequencing, the emotional index for this article in the Baby Boomers group is updated from 63% to 65% due to FUNNYSPORT47's reaction.

Regardless of whether the article cataloging management program 110a and 110b determines that the real-time reaction to the article is not different than the predicted reader reaction at 504, or the real-time reaction to the article is different than the predicted reader reaction at 504, the article cataloging management program 110a and 110b determines whether both an emotion-related algorithm and a cognitive learning algorithm are accurate at 508. The perfection of the emotion-related and cognitive learning algorithms may improve the ability of the article cataloging management program 110a, 110b to accurately predict a reader 202's reaction to an arbitrary article. The emotion-related algorithm may categorize the emotional index to the read article, and the cognitive learning algorithm may utilize the extracted data on the reader 202 to calculate the real-time reader reaction to the read article.

Additionally, the emotion-related algorithm may include a known emotional categorization and an emotional index on a read article. The cognitive learning algorithm may include real-time reader 202's emotion prediction on a given article in which the article cataloging management program 110a, 110b compares the reader reaction to an existing emotion prediction service. The cognitive learning algorithm may also include the real-time reader reaction as generated by the article cataloging management program 110a, 110b, and cognitively updates the reader 202 emotional index for the read article.

If the article cataloging management program 110a and 110b determines that the emotion-related and cognitive learning algorithms are accurate, the article cataloging management program 110a, 110b increases the weights of used input of the algorithms at 510. Since the predicted reaction matches the real-time reaction of the reader 202 at 502, the emotion-related and the cognitive learning algorithms may be considered accurate. As such, increased weight may be placed on the used inputs of the algorithms utilized to generate the predicted reaction.

Continuing the previous example, if the article cataloging management program 110a, 110b utilized the reader 202's pace of breathing to calculate the predicted reaction of the reader 202, then the importance or weight of the reader 202's pace of breathing maybe considered. If there was no difference between the predicted reader reaction and real-time reader reaction, then the algorithms would be considered accurate and greater weight or importance would be placed on the reader 202's pace of breathing when determining the predicted reaction.

If, however, the article cataloging management program 110a and 110b determines that the known emotion-related or cognitive learning algorithms are inaccurate at 508, then the article cataloging management program 110a, 110b reduces the weights of used inputs for the algorithms at 512. Since the predicted reaction is different from the real-time reaction, the article cataloging management program 110a, 110b may reduce the inputs utilized to generate the emotion-related and cognitive learning algorithms.

Continuing the previous example, to generate the predicted reaction, the article cataloging management program 110a, 110b utilized the accelerated heart rate of the reader 202. However, since the predicted reaction and real-time reaction was different by 10%, the algorithms are inaccurate and failed to accurately extract the data for the predicted reaction to match the real-time reaction to an article. As such, the article cataloging management program 110a, 110b reduces the weight or importance of the reader 202's heart rate to calculate the predicted reaction.

In the present embodiment, if either the emotion-related or cognitive learning algorithm are inaccurate, then the used inputs of both algorithms may be reduced by the article cataloging management program 110a, 110b.

Regardless of whether the weights of the used inputs were increased at 510 or reduced at 512, the article cataloging management program 110a, 110b updates both algorithms at 514. The algorithms may be updated based on whether the used inputs are increased at 512 or reduced at 510.

Continuing the previous example, the predicted reaction was inaccurate, the emotion-related and cognitive learning algorithms are updated to reflect the reduction in weight for the use of the reader 202's heart rate or pace of breathing to predict FUNNYSPORT47's reaction to the article on the recent advancements in gene sequencing.

Then, at 516, the article tags are updated based on reaction comparison. The article cataloging management program 110a, 110b may utilize the known cognitive emotional tag learning-based customizer to tag the articles. The articles in which the predicted reaction matches the real-time reaction may keep the original reaction tags for the specific reader group associated with the reader 202. However, the articles in which the predicted reaction fails to match the real-time reaction may receive updated reaction tags for the specific reader group associated with the reader 202. The articles with the applicable reaction tags may be saved in the article pool and library with emotional tags 212.

Continuing the previous example, since the predicted reaction fails to match the real-time reaction for the article on the recent advancements of gene sequencing, the article receives an updated reaction tag. The article with the corresponding reaction tag is saved in the article pool and library with emotional tags 212.

In the present embodiment, each newly arbitrary collected article may be re-classified with an updated emotional index from the default emotional index value during the reaction updating process 210 after the real-time reaction of the reader 202 is monitored and digitized during the reaction verification process 208.

Referring now to FIG. 6, an operational flowchart illustrating the exemplary process for managing article cataloging in server-side 600 used by the article cataloging management program 110a and 110b according to at least one embodiment is depicted.

At 602, the criteria are defined by the article cataloging management program 110a, 110b. The article cataloging management program 110a, 110b may define the criteria of the user groups (i.e., article reading groups), article emotional reaction dimensions and patterns (i.e., emotional dimensions), and reading reaction index (i.e., emotional index) prior to using the article cataloging management program 110a, 110b for the first time, or at another time thereafter. The defined criteria may be utilized in the reaction prediction process 206 of the article cataloging management program 110a, 110b.

The article cataloging management program 110a, 110b may utilize an emotional tag configuration graphical user interface (GUI) for configuring emotional tag settings and managing personal characteristics information (e.g., name, age, ethnicity, education, occupation, hobbies, interests). A set of personal emotional tagging criteria (e.g., standard thresholds of each personal emotional change level on different data and dimensions including text, voice, heart rate and facial expression) may be configured through the GUI and saved within the user profiles. A personal emotional tagging criteria may include markers to indicate where the reader 202 expresses a change in emotion. For example, if a normal heart rate of an adult is between 50-100 heartbeats per minute, when the reader 202 exhibits a heart rate exceeding 100 heart beats per minute the personal emotion tagging criteria will determine that the person is excited, anxious or angry. Additionally, the article cataloging management program 110a, 110b may utilize a known personal characteristic parser (i.e., program or module) to parse through personal characteristics saved on the user profiles.

For example, the reader 202 utilizes the emotional tag configuration GUI to manage personal characteristics information and configure emotional tag settings. In the emotional tag settings, the reader 202 previously selected the Emotional Dimensions and Index standard. In addition, the personal characteristics of the reader 202 are presented in the user profile. The personal characteristics (e.g., optimistic, trustworthy, honest, intelligent) are manually entered by the reader 202 when the reader 202 initially sets up the user profile.

In another embodiment, on the main screen for the article cataloging management program 110a, 110b, there may be a “Criteria” button located at the bottom right side of the screen. Once the reader 202 clicks on the “Criteria” button, the reader 202 may be prompted (e.g., via a dialog box) with a list of default or preset emotional dimensions, index and user groups. If the reader 202 clicks on one of the criteria, the reader 202 may be provided (e.g., via dialog box) with additional information on previously determined criteria. For example, once the reader 202 clicks on the “Emotional Dimensions and Index” criteria, then a dialog box appears stating “Emotional Dimensions and Index: International Affective Blog System (IAPS).” If the reader 202 clicks on “International Affective Bog System (IAPS),” then the reader 202 is directed to a web browser for more information related to the “International Affective Bog System (IAPS).” If, however, the reader 202 clicks on “Emotional Dimensions and Index,” then another dialog box will appear with information on when the criteria was selected, such as the date, the reader 202 who changed the criteria and a history of the past ten selections for “Emotional Dimensions and Index.”

Then, at 604, personal characteristics of the reader 202 are retrieved. Since the article cataloging management program 110a, 110b may have previously identified the reader 202, the article cataloging management program 110a, 110b may retrieve the personal characteristics of the reader 202 from the user profile (e.g., a file or database 114 for saving the personal characteristics of the reader 202) and reading history via communications network 116.

Continuing the previous example, after the reader 202 named “FUNNYSPORT47” is identified, a screen appears with two tabs, “Personal Characteristics” and “Reading History,” located on the right of the screen. When the user clicks the “Reading History” tab, the 45 articles read by the reader 202 on the article cataloging management program 110a, 110b, since the reader 202 started this user profile, are listed. When the user clicks the “Personal Characteristics” tab, then the reader 202's personal characteristics information is listed. The reader 202's personal characteristics information include that the reader 202 was born in 1947, enjoys cooking and sports, and currently works as a senior front-end developer with a tech start-up company.

In another embodiment, the article cataloging management program 110a, 110b may include the created user profiles in the article pool and library with emotional tags 212 so long as proper security precautions are adhered to.

Then, at 606, the reader 202 is categorized into user groups (i.e., article user groups). Based on the collected and saved personal characteristics information of the reader 202, the article cataloging management program 110a, 110b may utilize a known article reader categorizer to categorize different readers 202 into different user groups. Therefore, readers 202 with similar personal characteristics may be placed in the same user group.

Continuing the previous example, based on the reader 202's personal characteristics, the reader 202 is categorized in the Baby Boomers user group, Front-End Development user group, sports enthusiasts user group, and culinary user group.

Then, at 608, the user emotion and activities are received. The article cataloging management program 110a, 110b may utilize the emotional reaction tagging daemon to collect the created, modified or updated emotional index to the article from the reader 202's device (e.g., client computer 102). The article cataloging management program 110a, 110b may also collect the reader 202's other activities (e.g., sharing, comments, press “Like” or “Dislike” buttons) in response to the article by utilizing a known activity collecting engine. Additionally, based on the received user emotion and reader 202 activities, the tag corresponding to each article and the associated emotional index may be updated and merged by the emotional reaction tagging daemon. If the predicted reader reaction was different from the real-time reader reaction to an article, then the article cataloging management program 110a, 110b may receive the updated emotional index for the article generated at 506.

Continuing the previous example, when the user was reading the article on recent advancements on gene sequencing, the article cataloging management program 110a, 110b collected the Article-i of the reader 202, as well as the reader 202's activities. While reading the article, the reader 202 commented on the sections related to the use of software to modify artificial gene sequencing for cancer research, and indicated positive feedback on the article by clicking the “Like” button under the icon for the article in the article browser. In addition, the reader 202, after reading the article, shared the article to several of the reader 202's friends in the Baby Boomers user group. These activities of commenting, clicking the “Like” button and sharing indicate positive feedback.

Then, at 610, the article is sorted, and the reactions of the readers 202 to each article are categorized. After the reader reaction is updated and the retrieved article is tagged, each article may be sorted. A known sorting engine may be utilized to sort the article based on the tagged emotional index for a certain user group to enable easy retrieval of articles for the user group. Additionally, the article cataloging management program 110a, 110b may search and filter the retrieved article based on the tagged emotional index for the different user groups.

Additionally, the reactions of the readers 202 to each article are categorized. The categorized reactions to each article may be stored in the article pool and library with emotional tags 212. The categorized reactions may then be utilized to predict reader reactions to other articles.

Continuing the previous example, the article is then organized closer to the article with the highest Article-i for the user groups associated with the reader 202, Baby Boomers user group, Front-End Development user group, sports enthusiasts user group, and culinary user group, with the emotional tag in the article pool and library with emotional tags 212.

Then, at 612, reader reactions to an arbitrary article are predicted by the article cataloging management program 110a, 110b. The article cataloging management program 110a, 110b may utilize the emotional reaction tagging daemon to predict the user reaction to an arbitrary article (i.e., predicted arbitrary reaction). The article cataloging management program 110a, 110b may search for the class information (e.g., types of articles and emotional index associated with the new reader 202's reaction) associated with the arbitrary article, and then search for the updated reader reaction to other articles in the same class.

Continuing the previous example, based on the Article-i associated with the article, the article cataloging management program 110a, 110b can predict that this article may be favorable to readers 202 in the Baby Boomers user group. Therefore, the article cataloging management program 110a, 110b may predict that an arbitrary article with a similar subject matter may have a high emotional index such as this article on recent advancements in gene sequencing.

In the present embodiment, the article cataloging management program 110a, 110b may determine a class by generating an emotional index for an arbitrary article based on the reader 202's reaction, or updating an emotional index of a read article as needed based on the reader 202's reaction.

In an alternate embodiment, the article cataloging management program 110a, 110b may include a limit to the number or type of articles in the same class. The user may configure a limit on the number of articles in a particular class in the article cataloging management program 110a, 110b. For example, if the user only cares about a positive reaction on a breaking news story, then the article cataloging management program 110a, 110b may limit the articles to those articles with certain keywords.

In an alternate embodiment, the article cataloging management program 110a, 110b may utilize the context of the read article to modify the emotional index. For example, with the article on gene sequencing, if the reader 202 includes a “Like” next to the sections referring to the benefits of software development in the article, and a “Dislike” next to the specific types of cancer mentioned in the article, then the context associated with the “Like” and “Dislike” comments may be utilized to calculate the overall emotional index for the article.

In an alternate embodiment, the article cataloging management program 110a, 110b may utilize a known cognitive emotional tag learning-based customizer (i.e., a module in the emotional reaction tagging daemon) to customize the emotional tags associated with the article based on the personal characteristics of the reader 202. The customized emotional tag associated with the article may then be stored in the article pool and library with emotional tags 212.

In an alternate embodiment, the article cataloging management program 110a, 110b may collect user emotional reactions to images (e.g., photographs, drawings), and create a catalog of images with emotional tags associated with the reader 202 or user groups.

It may be appreciated that FIGS. 2-6 provide only an illustration of one embodiment and do not imply any limitations with regard to how different embodiments may be implemented. Many modifications to the depicted embodiment(s) may be made based on design and implementation requirements.

FIG. 7 is a block diagram 900 of internal and external components of computers depicted in FIG. 1 in accordance with an illustrative embodiment of the present invention. It should be appreciated that FIG. 7 provides only an illustration of one implementation and does not imply any limitations with regard to the environments in which different embodiments may be implemented. Many modifications to the depicted environments may be made based on design and implementation requirements.

Data processing system 902, 904 is representative of any electronic device capable of executing machine-readable program instructions. Data processing system 902, 904 may be representative of a smart phone, a computer system, PDA, or other electronic devices. Examples of computing systems, environments, and/or configurations that may represented by data processing system 902, 904 include, but are not limited to, personal computer systems, server computer systems, thin clients, thick clients, hand-held or laptop devices, multiprocessor systems, microprocessor-based systems, network PCs, minicomputer systems, and distributed cloud computing environments that include any of the above systems or devices.

User client computer 102 and network server 112 may include respective sets of internal components 902a, b and external components 904a, b illustrated in FIG. 7. Each of the sets of internal components 902a, b includes one or more processors 906, one or more computer-readable RAMs 908 and one or more computer-readable ROMs 910 on one or more buses 912, and one or more operating systems 914 and one or more computer-readable tangible storage devices 916. The one or more operating systems 914, the software program 108 and the article cataloging management program 110a in client computer 102, and the article cataloging management program 110b in network server 112, may be stored on one or more computer-readable tangible storage devices 916 for execution by one or more processors 906 via one or more RAMs 908 (which typically include cache memory). In the embodiment illustrated in FIG. 7, each of the computer-readable tangible storage devices 916 is a magnetic disk storage device of an internal hard drive. Alternatively, each of the computer-readable tangible storage devices 916 is a semiconductor storage device such as ROM 910, EPROM, flash memory or any other computer-readable tangible storage device that can store a computer program and digital information.

Each set of internal components 902 a, b also includes a R/W drive or interface 918 to read from and write to one or more portable computer-readable tangible storage devices 920 such as a CD-ROM, DVD, memory stick, magnetic tape, magnetic disk, optical disk or semiconductor storage device. A software program, such as the software program 108 and the article cataloging management program 110a and 110b can be stored on one or more of the respective portable computer-readable tangible storage devices 920, read via the respective R/W drive or interface 918 and loaded into the respective hard drive 916.

Each set of internal components 902 a, b may also include network adapters (or switch port cards) or interfaces 922 such as a TCP/IP adapter cards, wireless Wi-Fi interface cards, or 3G or 4G wireless interface cards or other wired or wireless communication links. The software program 108 and the article cataloging management program 110a in client computer 102 and the article cataloging management program 110b in network server computer 112 can be downloaded from an external computer (e.g., server) via a network (for example, the Internet, a local area network or other, wide area network) and respective network adapters or interfaces 922. From the network adapters (or switch port adaptors) or interfaces 922, the software program 108 and the article cataloging management program 110a in client computer 102 and the article cataloging management program 110b in network server computer 112 are loaded into the respective hard drive 916. The network may comprise copper wires, optical fibers, wireless transmission, routers, firewalls, switches, gateway computers and/or edge servers.

Each of the sets of external components 904 a, b can include a computer display monitor 924, a keyboard 926, and a computer mouse 928. External components 904 a, b can also include touch screens, virtual keyboards, touch pads, pointing devices, and other human interface devices. Each of the sets of internal components 902 a, b also includes device drivers 930 to interface to computer display monitor 924, keyboard 926, and computer mouse 928. The device drivers 930, R/W drive or interface 918 and network adapter or interface 922 comprise hardware and software (stored in storage device 916 and/or ROM 910).

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Analytics as a Service (AaaS): the capability provided to the consumer is to use web-based or cloud-based networks (i.e., infrastructure) to access an analytics platform. Analytics platforms may include access to analytics software resources or may include access to relevant databases, corpora, servers, operating systems or storage. The consumer does not manage or control the underlying web-based or cloud-based infrastructure including databases, corpora, servers, operating systems or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

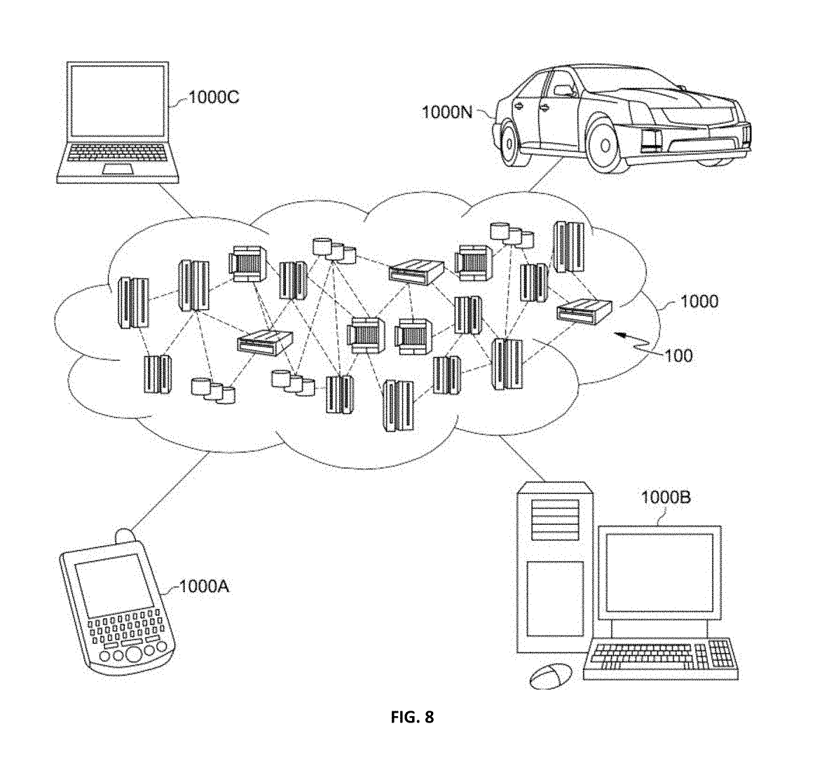

Referring now to FIG. 8, illustrative cloud computing environment 1000 is depicted. As shown, cloud computing environment 1000 comprises one or more cloud computing nodes 100 with which local computing devices used by cloud consumers, such as, for example, personal digital assistant (PDA) or cellular telephone 1000A, desktop computer 1000B, laptop computer 1000C, and/or automobile computer system 1000N may communicate. Nodes 100 may communicate with one another. They may be grouped (not shown) physically or virtually, in one or more networks, such as Private, Community, Public, or Hybrid clouds as described hereinabove, or a combination thereof. This allows cloud computing environment 1000 to offer infrastructure, platforms and/or software as services for which a cloud consumer does not need to maintain resources on a local computing device. It is understood that the types of computing devices 1000A-N shown in FIG. 8 are intended to be illustrative only and that computing nodes 100 and cloud computing environment 1000 can communicate with any type of computerized device over any type of network and/or network addressable connection (e.g., using a web browser).

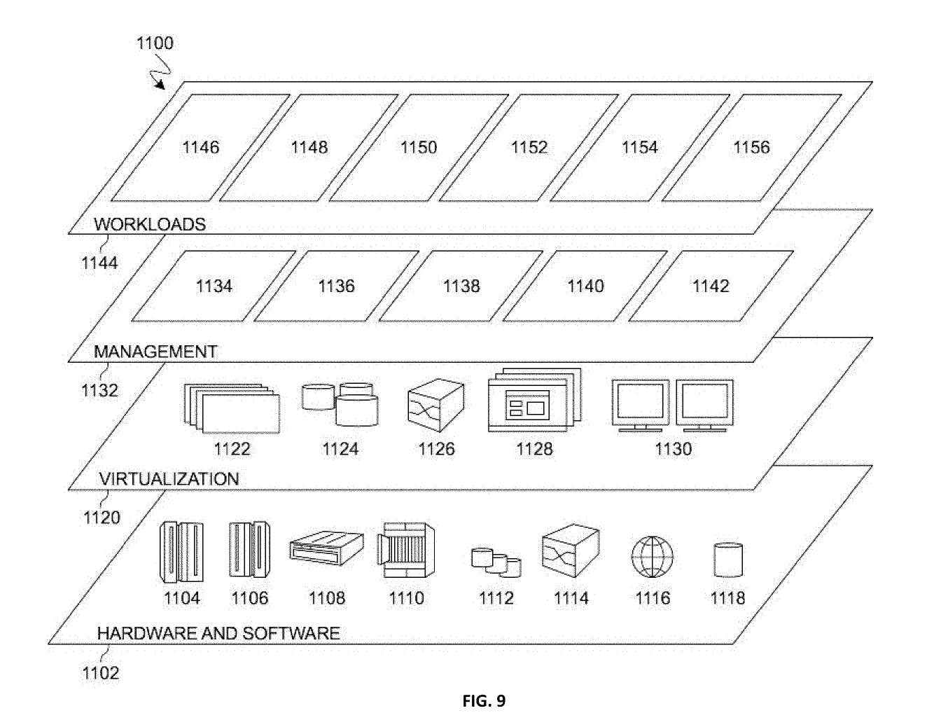

Referring now to FIG. 9, a set of functional abstraction layers 1100 provided by cloud computing environment 1000 is shown. It should be understood in advance that the components, layers, and functions shown in FIG. 9 are intended to be illustrative only and embodiments of the invention are not limited thereto. As depicted, the following layers and corresponding functions are provided:

Hardware and software layer 1102 includes hardware and software components. Examples of hardware components include: mainframes 1104; RISC (Reduced Instruction Set Computer) architecture based servers 1106; servers 1108; blade servers 1110; storage devices 1112; and networks and networking components 1114. In some embodiments, software components include network application server software 1116 and database software 1118.

Virtualization layer 1120 provides an abstraction layer from which the following examples of virtual entities may be provided: virtual servers 1122; virtual storage 1124; virtual networks 1126, including virtual private networks; virtual applications and operating systems 1128; and virtual clients 1130.

In one example, management layer 1132 may provide the functions described below. Resource provisioning 1134 provides dynamic procurement of computing resources and other resources that are utilized to perform tasks within the cloud computing environment. Metering and Pricing 1136 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 1138 provides access to the cloud computing environment for consumers and system administrators. Service level management 1140 provides cloud computing resource allocation and management such that required service levels are met. Service Level Agreement (SLA) planning and fulfillment 1142 provide pre-arrangement for, and procurement of, cloud computing resources for which a future requirement is anticipated in accordance with an SLA.

Workloads layer 1144 provides examples of functionality for which the cloud computing environment may be utilized. Examples of workloads and functions which may be provided from this layer include: mapping and navigation 1146; software development and lifecycle management 1148; virtual classroom education delivery 1150; data analytics processing 1152; transaction processing 1154; and article cataloging management 1156. An article cataloging management program 110a, 110b provides a way to manage reader reaction learning based article cataloging.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for managing article cataloging based on predicting, verifying and updating an individual reader reaction, the method comprising:
identifying a reader;
retrieving a plurality of personal characteristics associated with the identified reader in a user profile associated with the identified reader;
categorizing the identified reader into a plurality of user groups based on the retrieved plurality of personal characteristics associated with the identified reader in the user profile associated with the identified reader;
selecting an article by the identified reader;
retrieving the selected article;
predicting a predicted reaction of the identified reader to the retrieved article;
monitoring a real-time reaction of the identified reader to the retrieved article;
comparing the monitored real-time reaction of the identified reader to the predicted reaction of the identified reader to the retrieved article; and
updating the monitored real-time reaction of the identified reader into a piece of metadata associated with the retrieved article.

2. The method of claim 1, wherein monitoring the real-time reaction of the identified reader to the retrieved article, further comprises:
utilizing at least one biometric detection device associated with reader's device.

3. The method of claim 1, further comprising:
classifying an arbitrary article into a specific class of articles based on the categorized plurality of user groups and a plurality of article types associated with the arbitrary article, wherein a predicted arbitrary reaction of the identified reader to the arbitrary article is determined based on the updated real-time reaction of the identified reader to the retrieved article in the same class.

4. The method of claim 1, wherein comparing the monitored real-time reaction of the identified reader to the predicted reaction of the identified reader to the retrieved article, further comprises:
determining a difference between the monitored real-time reaction of the identified reader and the predicted reaction of the identified reader;
updating an emotional index associated with the retrieved article based on the determined difference between the categorized reaction of the reader and the predicted reaction of the reader; and
storing, in an article pool and library with emotional tags, the updated emotional index to the retrieved article.

5. The method of claim 1, further comprising:
collecting data related to a plurality of activities performed by the identified reader to the retrieved article.

6. The method of claim 1, further comprising:
selecting at least one standard for emotional dimensions and index;
detecting an emotion from the identified reader based on the selected standard for emotional dimensions and index, wherein the identified reader is reading the retrieved article;
generating an emotional index from the detected emotion of the identified reader to the retrieved article;
digitizing the generated emotional index to the retrieved article; and
updating the digitized emotional index to the retrieved article.

7. The method of claim 6, further comprising:
creating an emotional tag based on the digitized emotional index to the retrieved article;
associating the created emotional tag with the corresponding retrieved article; and
storing the associated emotional tag with the corresponding retrieved article in an article pool and library with emotional tags.

8. The method of claim 1, further comprising:
sorting the retrieved article based on an emotional tag associated with the retrieved article; and
storing the retrieved article with the corresponding emotional tag in an article pool and library with emotional tags.

9. The method of claim 1, further comprising:
searching and filtering a plurality of stored articles in an article pool and library with emotional tags based on the emotional tags corresponding with each of the stored articles in the plurality of stored articles from the categorized plurality of user groups and the identified reader.

10. A computer system for managing article cataloging based on predicting, verifying and updating an individual reader reaction, comprising:
one or more processors, one or more computer-readable memories, one or more computer-readable tangible storage medium, and program instructions stored on at least one of the one or more tangible storage medium for execution by at least one of the one or more processors via at least one of the one or more memories, wherein the computer system is capable of performing a method comprising:
identifying a reader;
retrieving a plurality of personal characteristics associated with the identified reader in a user profile associated with the identified reader;
categorizing the identified reader into a plurality of user groups based on the retrieved plurality of personal characteristics associated with the identified reader in the user profile associated with the identified reader;
selecting an article by the identified reader;
retrieving the selected article;
predicting a predicted reaction of the identified reader to the retrieved article;
monitoring a real-time reaction of the identified reader to the retrieved article;
comparing the monitored real-time reaction of the identified reader to the predicted reaction of the identified reader to the retrieved article; and
updating the monitored real-time reaction of the identified reader into a piece of metadata associated with the retrieved article.

11. The computer system of claim 10, wherein monitoring the real-time reaction of the identified reader to the retrieved article, further comprises:
utilizing at least one biometric detection device associated with reader's device.

12. The computer system of claim 10, further comprising:
classifying an arbitrary article into a specific class of articles based on the categorized plurality of user groups and a plurality of article types associated with the arbitrary article, wherein a predicted arbitrary reaction of the identified reader to the arbitrary article is determined based on the updated real-time reaction of the identified reader to the retrieved article in the same class.

13. The computer system of claim 10, wherein comparing the monitored real-time reaction of the identified reader to the predicted reaction of the identified reader to the retrieved article, further comprises:
determining a difference between the monitored real-time reaction of the identified reader and the predicted reaction of the identified reader;
updating an emotional index associated with the retrieved article based on the determined difference between the categorized reaction of the reader and the predicted reaction of the reader; and
storing, in an article pool and library with emotional tags, the updated emotional index to the retrieved article.

14. The computer system of claim 10, further comprising:
collecting data related to a plurality of activities performed by the identified reader to the retrieved article.

15. The computer system of claim 10, further comprising:
selecting at least one standard for emotional dimensions and index;
detecting an emotion from the identified reader based on the selected standard for emotional dimensions and index, wherein the identified reader is reading the retrieved article;
generating an emotional index from the detected emotion of the identified reader to the retrieved article;
digitizing the generated emotional index to the retrieved article; and
updating the digitized emotional index to the retrieved article.

16. The computer system of claim 15, further comprising:
creating an emotional tag based on the digitized emotional index to the retrieved article;
associating the created emotional tag with the corresponding retrieved article; and
storing the associated emotional tag with the corresponding retrieved article in an article pool and library with emotional tags.

17. The computer system of claim 10, further comprising:
sorting the retrieved article based on an emotional tag associated with the retrieved article; and
storing the retrieved article with the corresponding emotional tag in an article pool and library with emotional tags.

18. The computer system of claim 10, further comprising:
searching and filtering a plurality of stored articles in an article pool and library with emotional tags based on the emotional tags corresponding with each of the stored articles in the plurality of stored articles from the categorized plurality of user groups and the identified reader.

19. A computer program product for managing article cataloging based on predicting, verifying and updating an individual reader reaction, comprising:
one or more computer-readable storage media and program instructions stored on at least one of the one or more tangible storage media, the program instructions executable by a processor to cause the processor to perform a method comprising:
identifying a reader;
retrieving a plurality of personal characteristics associated with the identified reader in a user profile associated with the identified reader;
categorizing the identified reader into a plurality of user groups based on the retrieved plurality of personal characteristics associated with the identified reader in the user profile associated with the identified reader;
selecting an article by the identified reader;
retrieving the selected article;
predicting a predicted reaction of the identified reader to the retrieved article;
monitoring a real-time reaction of the identified reader to the retrieved article;
comparing the monitored real-time reaction of the identified reader to the predicted reaction of the identified reader to the retrieved article; and
updating the monitored real-time reaction of the identified reader into a piece of metadata associated with the retrieved article.

20. The computer program product of claim 19, wherein comparing the monitored real-time reaction of the identified reader to the predicted reaction of the identified reader to the retrieved article, further comprises:
determining a difference between the monitored real-time reaction of the identified reader and the predicted reaction of the identified reader;
updating an emotional index associated with the retrieved article based on the determined difference between the categorized reaction of the reader and the predicted reaction of the reader; and
storing, in an article pool and library with emotional tags, the updated emotional index to the retrieved article.
